(19) United States
(12) Patent Application Publication
(10) Pub. No.: US 2024/0424611 A1
(43) Pub. Date: Dec. 26, 2024

(54) WELDING PATH AUTONOMOUS OPTIMIZATION APPARATUS, WELDING PATH AUTONOMOUS OPTIMIZATION SYSTEM, AND WELDING PATH AUTONOMOUS OPTIMIZATION METHOD

(71) Applicant: HITACHI, LTD., Tokyo (JP)

(72) Inventors: Makoto OGATA, Tokyo (JP); Naoki MORIHIRA, Tokyo (JP)

(21) Appl. No.: 18/697,517

(22) PCT Filed: Sep. 7, 2022
(86) PCT No.: PCT/JP2022/033576

§ 371 Date: Apr. 1, 2024

(30) Foreign Application Priority Data
Nov. 9, 2021 (JP) 2021-182829

(51) Int. Cl. B23K 31/02; B23K 9/095; B23K 9/127; B23K 37/02

(52) U.S. Cl. CPC B23K 31/02; B23K 9/0953; B23K 9/0956; B23K 9/127; B23K 37/0252

(57) ABSTRACT

The welding path autonomous optimization system includes a quality—welding-condition correlation database in which a constraint condition of welding by a welding robot that operates a welding torch is stored, an interference analysis part configured to determine a welding path that does not interfere with an object to be welded based on three-dimensional CAD data of the object to be welded and the constraint condition stored in the quality—welding-condition correlation database, and a welding-robot-operation/welding-condition output part configured to output welding process information based on the welding path.

### CROSS-REFERENCE TO RELATED APPLICATION

This application is US National Stage of International Patent Application PCT/JP2022/033576, filed Sep. 7, 2022, which claims benefit of priority from Japanese Patent Application JP2021-182829, filed Nov. 9, 2021, the contents of both of which are incorporated herein by reference.

### BACKGROUND TECHNICAL FIELD

The present invention relates to a welding path autonomous optimization apparatus, welding path autonomous optimization system, and welding path autonomous optimization method.

### RELATED ART

Designing a welding process has in recent years come to involve a method of automatically calculating a welding path using a three-dimensional computer-aided design (CAD). Offline teaching analysis for avoiding interference between a welding torch and a workpiece to be welded is widely used, as represented by Patent Literature 1 (Japanese Unexamined Patent Application Publication No. 2012-24867). However, torch motion and detailed welding conditions such as a condition regarding a welding power source that are important for weld quality, such defects in a line weld of arc welding or the like, a bead shape, or a surface property, are not determined. Because of this, a condition optimization task that is based on an actual machine has been necessary after designing the welding process.

Further, in most cases, a positional relationship of a robot and non-welded workpiece that is found in a simulation result of offline teaching that is executed on a computer at the time of designing a welding process does not coincide with a positional relationship of the robot and non-welded workpiece at an actual welding site. An attempt has been made to correct the gap between the positional relationship of offline teaching and the positional relationship of actual welding by performing coordinate correction using a coordinate measuring machine before welding.

However, a characteristic that is required of a product that has been subjected to an arc welding process is to have a weld bead shape with a good surface property and no defect. Therefore, it is considered difficult to optimize the quality of a weld with a robot motion coordinate analysis for avoiding interference between a welding torch and a non-welded workpiece as has been performed in the above-described offline teaching.

Further, for tungsten inert gas (TIG) welding, an attempt has been made to create a database of welding skills of a skilled welder by a method of attaching a camera to a welding torch so that image processing may be performed and quantifying a movement of the welding torch, a feed amount of a welding material, and a performance of a welding power supply.

By using the database of welding skills of a skilled welder, an influence of a workpiece to be welded before and during welding, a movement of the torch during welding, a welding material, and a welding power source on a quality of a weld becomes predictable.

The method of Patent Literature 1 is characterized in that idle travel points of a welding gun, including an entry position and a retreating position, that are related to a welding movement are automatically determined by inputting information on a relative position between the gun held by a robot and a non- welded workpiece and information on a welding point for each welding point in spot welding. However, the method of Patent Literature 1 is not applicable to arc welding that performs continuous line welding or to a preliminary evaluation tool for obtaining a weld bead shape with a good surface property and no defect.

There is a teaching method for a welding robot that attempts to correct the gap between a positional relationship of offline teaching and a positional relationship of actual welding. By taking into account variations found with regards to a welding gun and a non-welded workpiece in an actual welding site for spot welding, this teaching method can correct a welding spot position in teaching data and prevent a decline in the accuracy of the teaching data. However, this teaching method is not applicable to arc welding that performs continuous line welding or to a preliminary evaluation tool for obtaining a weld bead shape with a good surface property and no defect.

### SUMMARY

An aspect of the present invention provides a welding path autonomous optimization apparatus that includes a database, an interference analysis part, and an output part. The database stores therein a constraint condition of welding by a welding robot that operates a welding torch. The interference analysis part is configured to determine a welding path that does not interfere with an object to be welded based on three-dimensional CAD data of the object to be welded and the constraint condition stored in the database. The output part is configured to output welding process information based on the welding path.

Another aspect of the present invention provides a welding path autonomous optimization system that includes a welding robot, a database, an interference analysis part, and an output part. The welding robot is configured to operate a welding torch. The database stores therein a constraint condition of welding by a robot. The interference analysis part is configured to determine a welding path that does not interfere with an object to be welded based on three-dimensional CAD data of the object to be welded and the constraint condition stored in the database. The output part is configured to output welding process information based on the welding path.

Another aspect of the present invention provides a welding path autonomous optimization method that includes determining, by an interference analysis part, a welding path that does not interfere with an object to be welded based on three-dimensional CAD data of the object to be welded and a constraint condition of welding by a welding robot, and outputting, by an output part, welding process information based on the welding path.

### BRIEF DESCRIPTION OF DRAWINGS

FIG. 1 is an overall view of a welding path autonomous optimization system according to a present embodiment.

FIG. 2 is a diagram showing a hardware configuration of and around a control device and an information processing device.

FIG. 3 is a diagram showing a configuration of an information processing device.

FIG. 4 is a diagram showing a logical configuration and operation of a welding path autonomous optimization system.

FIG. 5 is a diagram for explaining a torch tilt angle θ and a welding target position.

FIG. 6 is a diagram for explaining a torch drag angle.

FIG. 7 is a diagram for explaining a torch push angle.

FIG. 8 is a graph showing a correlation between welding result information and weld quality information.

### DETAILED DESCRIPTION

An embodiment of the present invention will be described in detail below with reference to the drawings.

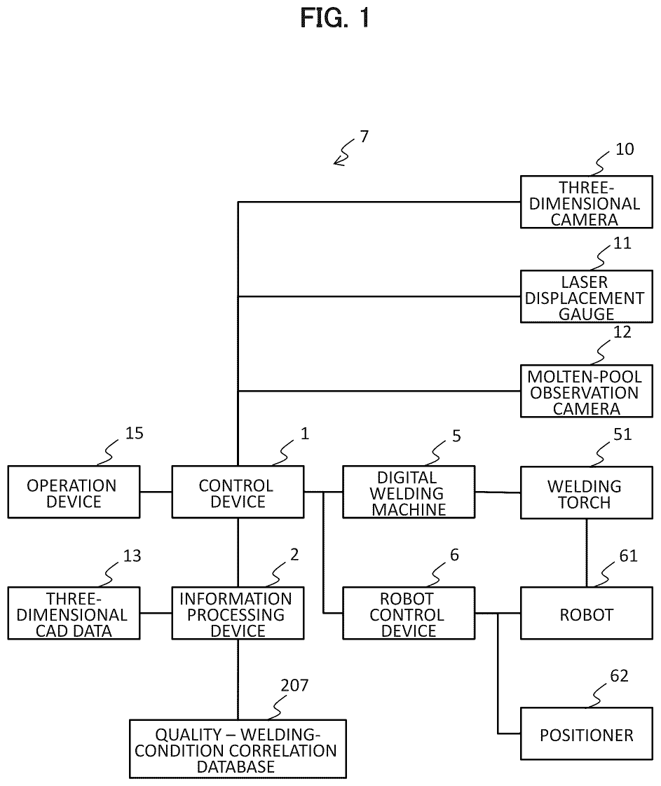

FIG. 1 is an overall view of a welding path autonomous optimization system 7 according to a present embodiment.

The welding path autonomous optimization system 7 is configured to include a control device 1 and an information processing device 2. The information processing device 2 is capable of accessing three-dimensional CAD data 13 and a quality—welding-condition correlation database 207 and is communicably connected to the control device 1. The information processing device 2 determines a welding path for an object to be welded that is related to the three-dimensional CAD data 13 and calculates welding process information off line.

The control device 1 is connected to a three-dimensional camera 10, a laser displacement gauge 11, a molten-pool observation camera 12, a digital welding machine 5, a robot control device 6, and an operation device 15. The control device 1 calls a welding path that has been determined under a constraint condition as time series data of a three-dimensional coordinate of a tip of a welding torch 51 and performs actual welding.

Geometric data of a robot 61 and a workpiece to be welded that is included in the three-dimensional CAD data 13 and a matter related to movement of the welding torch 51, such as a torch tilt angle or a distance between a torch tip and a workpiece, that is related to weld quality and is stored in the quality—welding-condition correlation database 207 are constraint conditions of welding.

The information processing device 2 calculates a welding path including an optimal movement of the welding torch 51 under the constraint conditions of welding and determines a torch tip movement that takes into consideration weld quality in offline teaching. By using the operation device 15, the welding path determined under the constraint conditions of welding is called by the control device 1 as the time series data of a three-dimensional coordinate of a tip of the welding torch 51.

The robot 61 is configured to operate the welding torch 51.

In relation to the time-series data of a three-dimensional coordinate of a tip of the welding torch 51, the control device 1 controls the digital welding machine 5 and the robot control device 6 before and during welding and corrects the welding path using the welding torch 51 and the robot 61, or a positioner 62 as necessary, based on measurement values (welding information) measured by various sensor devices exemplified below. The following various devices and the control device 1 are connected to each other by a connection cable (not shown).

The digital welding machine 5 can control a current, a voltage, an arc length, or a wire feed speed during welding based on an analog output (voltage or current) from the control device 1.

The robot control device 6 is communicably connected to the control device 1 and the information processing device 2 via a local area network (LAN) cable and a LAN port so that protocol communication is established in order to control coordinates of the robot 61 and the positioner 62.

The three-dimensional camera 10 is configured to capture an image of the welding torch 51, the robot 61, and/or the workpiece to be welded in a space between 0.01 m and 5 m prior to welding. The three-dimensional camera 10 functions as a three-dimensional scanner that detects a shape of a workpiece. The control device 1 three-dimensionally grasps positional relationship between the welding torch 51, robot 61, and workpiece to be welded from the image captured by the three-dimensional camera 10 and corrects the time-series data of a three-dimensional coordinate that has been determined by the information processing device 2. The three-dimensional camera 10 is communicably connected to the control device 1 and so that a protocol communication is established therewith.

The laser displacement gauge 11 is configured to three-dimensionally measure positional relationship between the welding torch 51, the workpiece to be welded, and a groove of the workpiece to be welded in a space between 0.01 mm and 500 mm before welding. Based on a position measured by the laser displacement gauge 11, the control device 1 corrects the time-series data of a three-dimensional coordinate that has been determined by using the three-dimensional camera 10 and the control device 1. The laser displacement gauge 11 is communicably connected to the control device 1 so that a protocol communication is established therewith. The laser displacement gauge 11 is a displacement gauge for identifying a relative position between the welding robot and the groove.

The molten-pool observation camera 12 is configured to capture an image during welding of the tip of the welding torch 51 and/or the groove of the workpiece to be welded in a space between 0.01 mm and 50 mm. The control device 1 three-dimensionally grasps positional relationship between the tip of the welding torch 51 and the groove of the workpiece with the image captured by the molten-pool observation camera 12 and corrects the time-series data of a three-dimensional coordinate that has been determined by using the laser displacement gauge 11 and the control device 1. The molten-pool observation camera 12 is communicably connected to the control device 1 so that a protocol communication is established therewith.

The present invention is not limited to a system in which a plurality of devices operate in cooperation with one another. The present invention may be a welding path autonomous optimization apparatus in which an operation is completed in a single device.

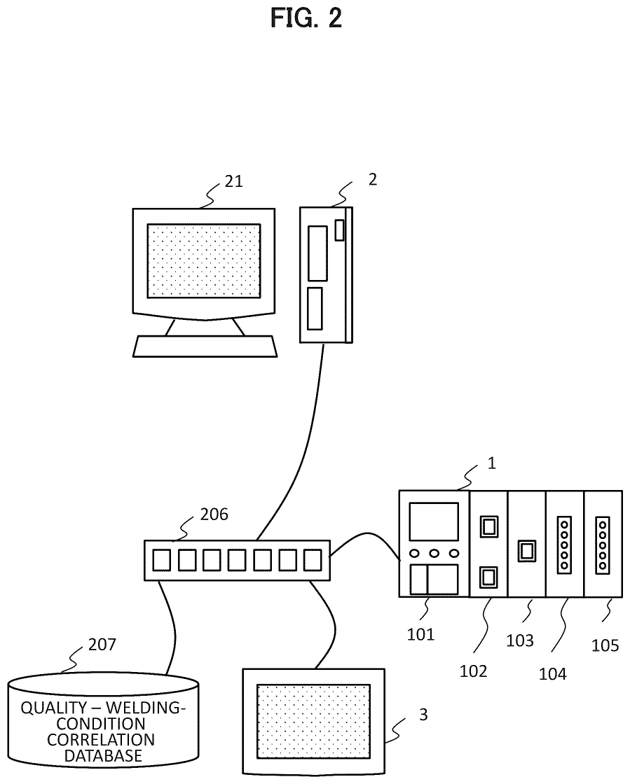

FIG. 2 is a diagram showing a hardware configuration of and around the control device 1 and the information processing device 2.

The control device 1 is, for example, configured as a programmable logic controller (PLC) and includes a central processing unit (CPU) unit 101 and, as additional units, a protocol communication unit 102, a database connection unit 103, an analog input unit 104, and an analog output unit 105. The PLC constituting the control device 1 may expand its function by attaching an additional unit to the CPU unit 101.

The protocol communication unit 102 communicates with the robot control device 6, the three-dimensional camera 10, the laser displacement gauge 11, and the molten-pool observation camera 12 via Ethernet (registered trademark).

The database connection unit 103 communicates with the quality—welding-condition correlation database 207 and a computer that operates as the information processing device 2.

The analog input unit 104 converts an analog input that is a voltage or a current of the digital welding machine 5 into digital data.

The analog output unit 105 converts into voltage or current based on the digital data of the digital welding machine 5 and controls an analog output. The digital data may be viewed and monitored via a hub 206 using a human machine interface (HMI) such as a monitor display 21 for the information processing device 2 or a tablet terminal used as the operation device 15 for the control device 1.

The welding information that is inputted to the control device 1 includes a current or voltage, an arc length, and a wire feed speed that are inputted from the digital welding machine 5 and obtained through the analog input unit 104.

Further, time series data of a three-dimensional coordinate of the tip of the welding torch 51 that is inputted from the robot control device 6 is obtained through the protocol communication unit 102 using Ethernet. Further, coordinate information of the welding torch 51, workpiece to be welded, and groove of the workpiece to be welded that is inputted from the three-dimensional camera 10 is obtained through the protocol communication unit 102 using Ethernet.

Further, information on the welding torch 51, the workpiece to be welded, and the groove of the workpiece to be welded that is inputted from the laser displacement gauge 11 is obtained through the analog input unit 104. Further, coordinate information of the tip of the welding torch 51 and the groove of the workpiece to be welded that is inputted from the molten-pool observation camera 12 is obtained through the protocol communication unit 102 using Ethernet (registered trademark).

The information on welding is temporarily stored in storage of the CPU unit 101 of the control device 1 and, through the database connection unit 103, is stored in the quality—welding-condition correlation database 207. By using the control device 1 to read an arbitrary value from the quality—welding-condition correlation database 207 after welding, the control device 1 may control an operation of the digital welding machine 5 or robot control device 6 and control an imaging condition of the three-dimensional camera 10, laser displacement gauge 11, or molten-pool observation camera 12.

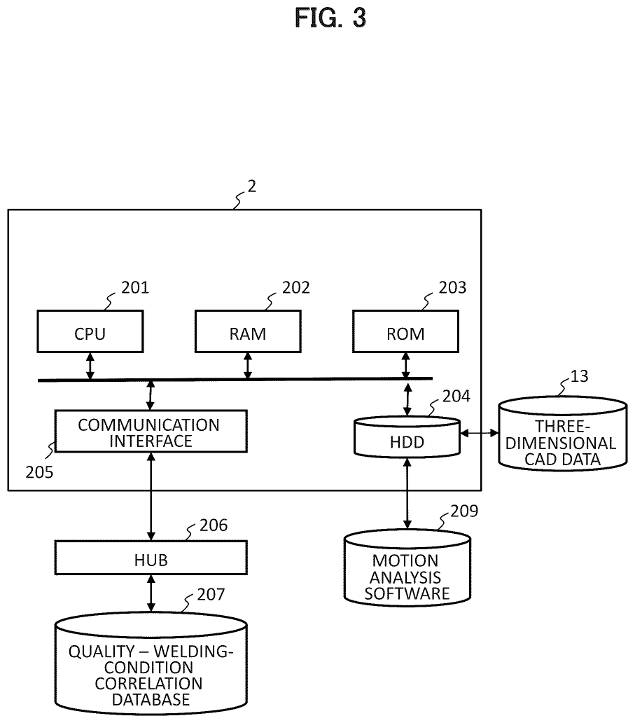

FIG. 3 is a diagram showing a configuration of the information processing device 2.

The information processing device 2 is configured as a computer that includes a central processing unit (CPU) 201, a random access memory (RAM) 202, a read only memory (ROM) 203, a hard disk drive (HDD) 204, and a communication interface 205.

The communication interface 205 is connected to the hub 206, which is an external communication device, and exchanges information with the quality—welding-condition correlation database 207. The three-dimensional CAD data 13 is stored and motion analysis software 209 is installed in the HDD 204, and data transmission and software execution are performed by the information processing device 2 as necessary.

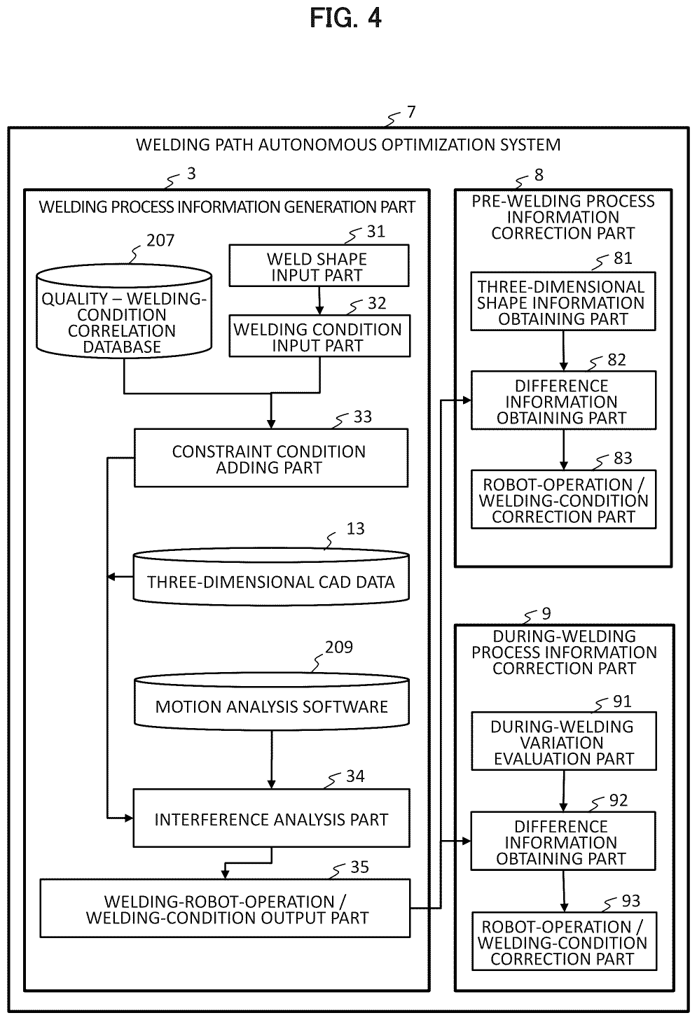

FIG. 4 is a diagram showing a logical configuration and operation of the welding path autonomous optimization system 7.

The welding path autonomous optimization system 7 includes a welding process information generation part 3, a pre-welding process information correction part 8, and a during-welding process information correction part 9. The welding path autonomous optimization system 7 performs a welding path autonomous optimization method. The welding path autonomous optimization method includes the following steps: a step of determining a welding path that does not interfere with an object to be welded based on the three-dimensional CAD data 13 of the object to be welded and a constraint condition of welding by the welding robot; and a step of outputting welding process information based on the welding path.

The welding process information generation part 3 includes a quality—welding-condition correlation database 207, a constraint condition adding part 33 for a constraint condition such as a torch tilt angle or welding target position, a weld shape input part 31, a welding condition input part 32, the three-dimensional CAD data 13, the motion analysis software 209, an interference analysis part 34, and a welding-robot-operation/welding-condition output part 35. The quality—welding-condition correlation database 207 is built before the welding path autonomous optimization system 7 is executed. The interference analysis part 34 is realized by the CPU 201 running the motion analysis software 209.

From the quality—welding-condition correlation database 207 and the weld shape and the welding condition inputted to the weld shape input part 31 and the welding condition input part 32, the constraint condition adding part 33 outputs information such as a torch tilt angle θ, a distance between the torch tip and the workpiece, or the like from a viewpoint of quality of a weld. The welding constraint condition outputted by the constraint condition adding part 33 and the three-dimensional CAD data 13 in combination become a constraint condition for the interference analysis part 34. The interference analysis part 34 performs motion interference analysis under this constraint condition. In this way, the interference analysis part 34 can find a robot operation that does not interfere with the workpiece while also satisfying a constraint condition of the torch or the like in view of quality.

The Applicant has found that welding performance information such as a movement or tilt angle of the welding torch 51, push/drag angle, welding target position, distance between the torch tip and the workpiece, or time history of current/voltage of the welding power source in robotic welding or manual welding correlates with weld quality information such as a flank angle, toe radius, bead width, bead height, leg length, or weld defect of a weld bead.

Further, the Applicant has found that the torch tilt angle of the welding torch 51 and the welding target position have a significant influence on a degree of sagging of a bead, which is an indicator of weld quality.

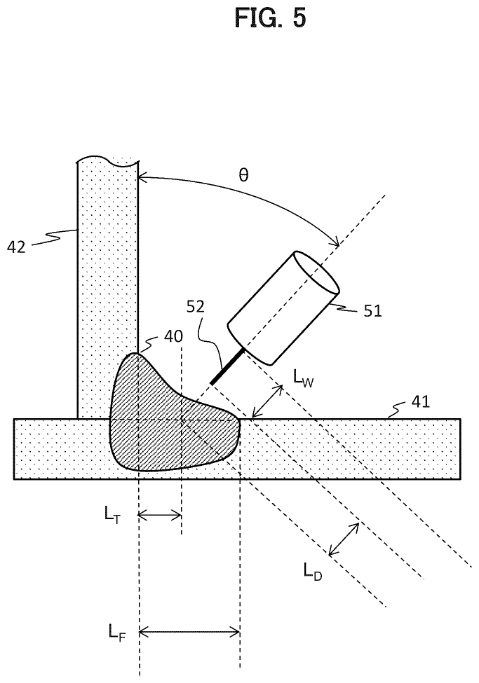

FIG. 5 is a diagram for explaining the torch tilt angle θ and the welding target position.

In FIG. 5, base materials 41 and 42 are planar, and the base material 42 is vertically supported on the base material 41 that is set up substantially horizontally. The welding torch 51 has a wire 52 feeding out at its tip by a length L_{W}. A distance L_{D} is a distance from the torch tip to where an imaginary line extending from the torch tip in the direction of the wire 52 reaches the base material 41. The “distance between the torch tip and the workpiece” refers to the distance L_{D}.

The welding torch 51 tilts by a predetermined torch tilt angle θ and moves, for example, to the back side of the drawing sheet. The torch tilt angle θ is a tilt angle of the welding torch 51 and is an angle of tilt from a vertical plane along a welding advancing direction.

A target position L_{T} indicates a distance from a vertex of an L shape formed by the flat plates of the base materials 41 and 42 to an intersection of an axis of the welding torch 51 and the base material 41. A leg length L_{F} of a molten bead 40 is a bead width and is a distance from a side formed by the flat plates of the base materials 41 and 42 to an end portion of the molten bead 40. The leg length L_{F} is an index indicating weld quality.

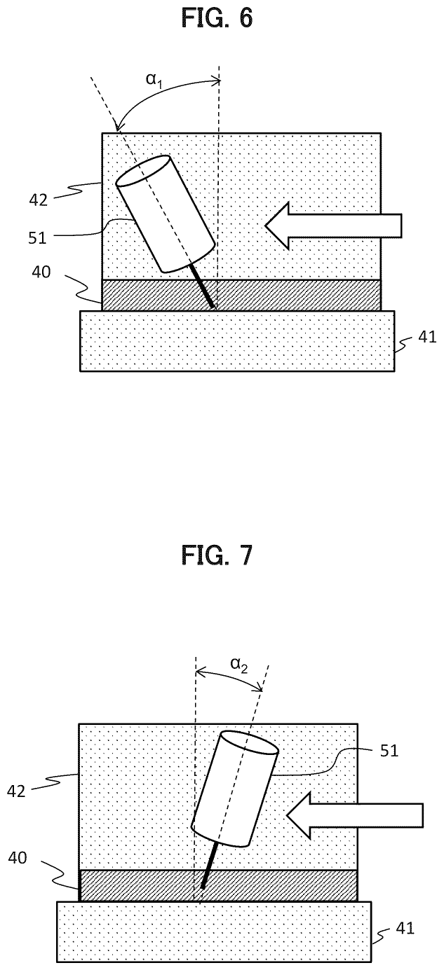

FIG. 6 is a diagram for explaining a torch drag angle.

In FIG. 6, base materials 41 and 42 are planar, and the base material 42 is vertically supported on the base material 41 that is substantially horizontally set up. The welding torch 51 moves to the left side of the drawing sheet, and a molten bead 40 is formed between the base materials 41 and 42. Here, a torch drag angle is a backhand angle α₁ of tilt toward the welding advancing direction of the welding torch 51.

FIG. 7 is a diagram for explaining a torch push angle.

In FIG. 7, base materials 41 and 42 are planar, and the base material 42 is vertically supported on the base material 41 that is substantially horizontally set up. The welding torch 51 moves to the left side of the drawing sheet, and a molten bead 40 is formed between the base materials 41 and 42. Here, a torch push angle is a forehand angle α₂ of tilt away from the welding advancing direction of the welding torch 51.

The Applicant has found that a power output of a welding machine has significant influence on weld quality, particularly on an undercut. Here, the power output of a welding machine is a product of the current flowing out of the welding machine and the voltage applied by the welding machine.

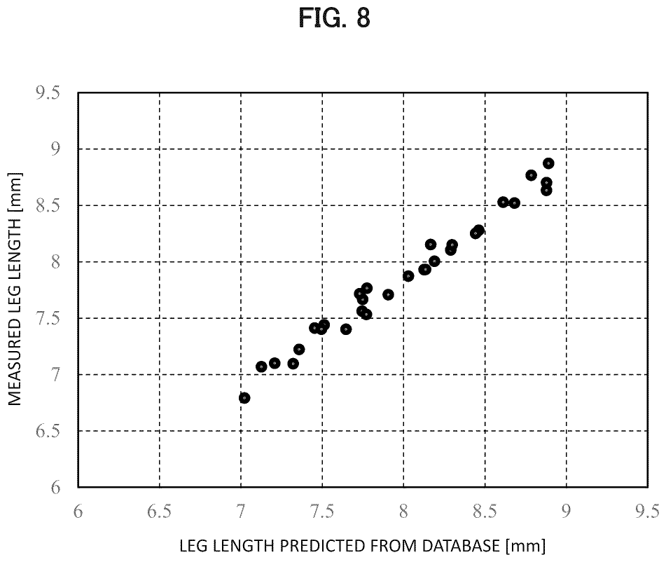

FIG. 8 is a graph showing a correlation between welding performance information and the weld quality information.

The horizontal axis of the graph represents a leg length that is predicted from the quality—welding-condition correlation database 207. The vertical axis represents a leg length that has been measured. The leg length is one of the weld quality information. Each plot indicates welding based on corresponding welding performance information and has a predetermined correlation. In this way, when the welding performance information is known, the weld quality information can be predicted.

Therefore, the welding path autonomous optimization system 7 identifies a relationship between the welding performance information and the weld quality information by a multivariate analysis or the like and stores a degree of influence of each of the welding performances on the weld quality in the quality—welding-condition correlation database 207 as a numerical value such as a correlation coefficient. The welding path autonomous optimization system 7 can calculate a welding path that ensures a predetermined weld quality by determining a welding path using the degree of influence of each of the welding performances on the weld quality as a constraint condition.

In a case where it is difficult to apply a multivariate analysis to the relationship between the welding performance information and the weld quality information, a correlation coefficient may be obtained by a machine learning method using artificial intelligence (AI).

Returning to FIG. 4, the description of the welding path autonomous optimization system 7 will be continued. The weld shape input part 31 is mainly inputted with information on a material of the workpiece to be welded and weld groove shape information. The information on a weld groove shape may include mill certificate information such as a steel type, a type of welding wire, a welding wire diameter, a welding method, a groove pattern (I-shape, V-shape, bevel-shape, Y-shape, K-shape, J-shape, X-shape, U-shape, H-shape, etc.), a groove angle, a root face length, a root gap length, roughness of the prepared groove, or the like.

The welding condition input part 32 is mainly inputted with a welding condition. Information on the welding condition may include a voltage that is set for the welding power source, a current, a welding speed, a weaving frequency, a weaving width, a feed rate of welding wire, a wire extension, a type and flow rate of shielding gas, time between passes in the case of multi-layer welding, presence or absence of chipping, or the like.

The three-dimensional CAD data 13 includes three-dimensional model information of the following: a workpiece to be welded including information of a groove shape, the robot 61, a jig for applying a restraint during welding, the positioner 62, and a weld bead of each layer. With regards to the information inputted with the weld shape input part 31 and the welding condition input part 32, the information may be inputted as an annotation in the three-dimensional CAD.

The interference analysis part 34 (see FIG. 4) is realized by running the motion analysis software 209 with the CPU 201 shown in FIG. 3. The interference analysis part 34 is capable of calculating quantitative information on kinematics, including position, speed, and acceleration of every component included in the three-dimensional CAD data 13, and dynamics, including joint reaction, inertia force, and power requirement. This function, which is often provided as a function of commercially available three-dimensional CAD software, is used in the welding process information generation part 3 to determine a welding path by offline teaching so that a motion of the welding robot does not interfere with the workpiece to be welded, the jig, and the positioner 62.

Based on the constraint condition such as the tilt angle of the welding torch 51 or the distance between the torch tip and the workpiece (a value substantially equal to a welding wire target position) obtained from the quality—welding-condition correlation database 207, the interference analysis part 34 changes the geometry of the three-dimensional CAD data 13 on software using an API (Application Programming Interface) of the three-dimensional CAD to determine a welding path. That is, the interference analysis part 34 determines a welding path that does not interfere with the object to be welded based on the three-dimensional CAD data 13 of the object to be welded and the constraint condition of the quality—welding-condition correlation database 207.

The interference analysis part 34 executes, for example, an angle, rotation, or the like of the welding torch 51 when changing the geometry. An absolute amount regarding the geometry change is determined by a multivariate analysis based on information that has been outputted from the weld shape input part 31 and the welding condition input part 32 and stored as annotation information in the three-dimensional CAD data 13 and on the quality—weld-condition correlation database 207.

The welding-robot-operation/welding-condition output part 35 outputs point data of a time-series trajectory change focusing on a coordinate system of the tip of the welding torch 51 of the robot 61 to a file in a comma-separated values (CSV) format or to the quality—welding-condition correlation database 207. The outputted data is imported by the control device 1. The welding-robot-operation/welding-condition output part 35 is an output part that outputs welding process information based on the welding path. The welding process information outputted by the welding-robot-operation/welding-condition output part 35 includes information on at least the torch tilt angle and the welding target position of the welding torch 51.

The pre-welding process information correction part 8 is, for example, embodied as part of the control device 1 shown in FIG. 1. The pre-welding process information correction part 8 includes a three-dimensional shape information obtaining part 81, a difference information obtaining part 82, and a robot-operation/welding-condition correction part 83. The pre-welding process information correction part 8 obtains three-dimensional shape information of the workpiece and groove shape information prior to welding with the three-dimensional camera 10, identifies a difference from the three-dimensional CAD data 13, and corrects the welding process information.

The three-dimensional shape information obtaining part 81 obtains three-dimensional shape information of the workpiece prior to welding using the three-dimensional camera 10, the laser displacement gauge 11, or the like and aggregates the three-dimensional shape information of the workpiece. The three-dimensional shape information obtaining part 81 obtains three-dimensional shape information of the object to be welded that includes at least one of three-dimensional shape information of the workpiece or groove shape information prior to welding.

By comparing the three-dimensional shape information of the workpiece obtained by the three-dimensional shape information obtaining part 81 with the outputted data of the welding-robot-operation/welding-condition output part 35, the difference information obtaining part 82 evaluates discrepancy between positional relationships. The difference information obtaining part 82 functions as a first difference information obtaining part that identifies a difference between (a) the three-dimensional shape information of the workpiece and the groove shape information and (b) the three-dimensional CAD data 13. In other words, the difference information obtaining part 82 identifies a difference between the three-dimensional CAD data 13 and the three-dimensional shape information of the object to be welded.

The robot-operation/welding-condition correction part 83 provides an instruction to the robot 61 based on the positional relationship discrepancy information outputted by the difference information obtaining part 82. That is, the robot-operation/welding-condition correction part 83 corrects the welding process information with the difference outputted by the difference information obtaining part 82.

With the pre-welding process information correction part 8, high quality robot welding is automatically executed by using a welding robot operation and welding condition obtained by the welding-robot-operation/welding-condition output part 35, a gap between positional relationships caused by a difference in workpiece arrangements on computer and in reality, accuracy of the prepared groove, or the like is automatically recognized, and a correction is made to the robot operation.

The during-welding process information correction part 9 includes a during-welding variation evaluation part 91, a difference information obtaining part 92, and a robot-operation/welding-condition correction part 93.

The during-welding variation evaluation part 91 obtains three-dimensional shape information of the workpiece during welding using the molten-pool observation camera 12 or the like and aggregates the three-dimensional shape information of the workpiece. Further, the during-welding variation evaluation part 91 evaluates a state of a molten pool during welding and a variation in a relative position with respect to the groove from an image captured by the molten-pool observation camera 12.

By comparing the three-dimensional shape information of the workpiece obtained by the during-welding variation evaluation part 91 with the outputted data of the welding-robot-operation/welding-condition output part 35, the difference information obtaining part 92 evaluates discrepancy between positional relationships. The difference information obtaining part 92 functions as a second difference information obtaining part that identifies a difference between the three-dimensional shape information of the workpiece obtained by the during-welding variation evaluation part 91 and the three-dimensional CAD data 13.

The robot-operation/welding-condition correction part 93 corrects the welding process information based on the positional relationship discrepancy information outputted by the difference information obtaining part 92 and provides an instruction on a robot motion based on the corrected welding process information. At this time, the robot-operation/welding-condition correction part 93 corrects either a position of the welding torch 51 or a welding condition based on the discrepancy between positional relationships.

With the during-welding process information correction part 9, high quality robot welding is automatically executed by using the welding robot operation and welding condition obtained by the welding-robot-operation/welding-condition output part 35, a gap between a positional relationship around a groove or the like on computer and a positional relationship around a groove or the like in reality is automatically recognized, and a correction is made to a robot operation.

The control device 1 shown in FIG. 1 passes information to the robot control device 6 shown in FIG. 1 as input for motion control of the robot 61 and the positioner 62. The information calculated by the control device 1 is inputted to the difference information obtaining part 82 prior to welding and is inputted to the difference information obtaining part 92 during welding as data.

At the three-dimensional shape information obtaining part 81, sensor data obtained from the three-dimensional camera 10, through scanning by the laser displacement gauge 11 that is mounted on the robot 61 or the like, or the like is inputted to the control device 1. The data received by the control device 1 is held in the control device 1 as point cloud data of three-dimensional coordinates in a form that can be compared with point cloud data of the three-dimensional CAD and is also sent to the information processing device 2.

The difference information obtaining part 82 successively calculates and outputs discrepancy between positional relationships by pattern matching or the like of the point cloud data obtained via the welding-robot-operation/welding-condition output part 35 and the point cloud data of the workpiece obtained by the three-dimensional shape information obtaining part 81 or the like. The difference information obtaining part 82 is embodied as part of the control device 1 but may be embodied as part of the information processing device 2.

The robot-operation/welding-condition correction part 83 changes a height of the welding torch 51 shown in FIG. 1 and a voltage/current setting value of the welding power source based on the successive values of the discrepancy between positional relationships that are obtained from the difference information obtaining part 82. Further, the robot-operation/welding-condition correction part 83 determines a change in welding speed, an addition of weaving, or a change in weaving width from a welding performance in the quality—welding-condition correlation database 207 with which similar weld quality is obtained. The robot-operation/welding-condition correction part 83 defines a new welding condition by tuning the condition of the constraint condition adding part 33 so that quality under the welding condition defined by the welding-robot-operation/welding-condition output part 35 can be reproduced for the data of the three-dimensional shape information obtaining part 81.

The molten-pool observation camera 12 mounted on the robot 61 of FIG. 1 obtains moving images of an area in front of the welding torch 51 or a molten pool while avoiding arc light and detects state information of the molten pool during welding. The moving images include image fluctuation caused by a welding phenomenon, and the during-welding variation evaluation part 91 quantitatively grasps numerical values such as a fluctuation of groove width in front of the welding torch 51 and a width of the molten pool from the moving images by using a technique such as deep learning.

The difference information obtaining part 92 sequentially compares the point cloud data obtained via the welding-robot-operation/welding-condition output part 35 with the fluctuation of groove width of the workpiece and the fluctuating value of the molten pool width obtained by the during-welding variation evaluation part 91 and outputs discrepancy between positional relationships by pattern matching or the like.

The robot-operation/welding-condition correction part 93 changes the height of the welding torch 51 and the voltage/current setting value of the welding power source based on the sequential values of the discrepancy between positional relationships obtained from the difference information obtaining part 92. Further, the robot-operation/welding-condition correction part 93 determines a change in welding speed, an addition of weaving, or a change in weaving width from a welding performance with which similar weld quality is obtained in the quality—welding-condition correlation database 207. The robot-operation/welding-condition correction part 93 defines a new welding condition by tuning the welding condition determined by the welding-robot-operation/welding-condition output part 35.

The present embodiment described above can provide an offline teaching system for a welding robot for high-quality execution of arc welding and a system for autonomously optimizing a robot welding path taught under variations in actual welding. The present embodiment enables welding with a welding robot trajectory that reflects welding deformation and molten pool variation.

The present embodiment further provides the following effects.

(1) The present embodiment can provide offline teaching for arc welding for a line weld as well as for spot welding.
(2) The present embodiment not only provides an offline teaching decision based on interference between the welding torch of the welding robot and the workpiece to be welded, but enables offline teaching that also focuses on an improvement in quality of a weld.
(3) The present embodiment can recognize variations between positional relationships of offline teaching and actual welding in arc welding and realize stable welding by correcting robot operation or a welding power source side from the difference.

### Modification

The present invention is not limited to the above-described embodiment, but includes various modifications. For example, the above-described embodiment has been described with details for ease of understanding of the present invention. The present invention is not limited to an embodiment that includes all of the configuration described above. A part of the configuration of a certain embodiment may be replaced with a configuration of another embodiment. A configuration of another embodiment may be added to a configuration of a certain embodiment. Further, it is possible to add another configuration to a part of the configuration of an embodiment, replace a part of the configuration of an embodiment with another configuration, or delete a part of the configuration of an embodiment.

Part or all of the above-described configuration, function, processing part, processing means, or the like may be realized by hardware such as an integrated circuit. Each of the above-described configuration, function, or the like may be realized by software by a processor interpreting and executing a program for realizing a respective function. Information such as a program for realizing each function, table, or file may be stored in a recording device such as a memory, hard disk, or solid state drive (SSD) or non-transitory storage medium such as a flash memory card or a digital versatile disk (DVD).

In each embodiment, control lines and information lines that are relevant to describing each embodiment are shown. Not all control lines and information lines that may be included in a product are necessarily shown. In practice, it may be considered that almost all the configurations are connected to each other.

Further, a communication means for connecting the devices is not limited to a wireless LAN and may be changed to a wired LAN or another communication means.

The Applicant considers that offline teaching of a welding robot for high-quality arc welding requires a system that is able to compensate for differences between offline teaching and various variations found in actual welding by combining calculation that uses numerical values of a coordinate system to avoid interference regarding geometry information obtained from CAD data with a database of factors that affect arc welding quality that has been quantified through an attempt to create a database of welding skills of a skilled welder.

An object of the present invention is to autonomously optimize welding process information of a welding robot.

According to the present invention, it is possible to autonomously optimize welding process information of a welding robot.

### REFERENCE SIGNS LIST

1 Control device
10 Three-dimensional camera
11 Laser displacement gauge (displacement gauge)
12 Molten-pool observation camera
13 Three-dimensional CAD data
101 CPU unit
102 Protocol communication unit
103 Database connection unit
104 Analog input unit
105 Analog output unit
15 Operation device
2 Information processing device
21 Monitor display

### 200 Computer

### 201 CPU

### 202 RAM

### 203 ROM

### 204 HDD

205 Communication interface
207 Quality-welding-condition correlation database (database)
209 Motion analysis software
5 Digital welding machine
51 Welding torch
6 Robot control device

### 61 Robot

### 62 Positioner

7 Welding path autonomous optimization system

### 206 Hub

3 Welding process information generation part
33 Constraint condition adding part
31 Weld shape input part
32 Welding condition input part
34 Interference analysis part
35 Welding-robot-operation/welding-condition output part (output part)
8 Pre-welding process information correction part
81 Three-dimensional shape information obtaining part
82 Difference information obtaining part (first difference information obtaining part)
83 Robot-operation/welding-condition correction part
9 During-welding process information correction part
91 During-welding variation evaluation part
92 Difference information obtaining part (second difference information obtaining part)
93 Robot-operation/welding-condition correction part

1. A welding path autonomous optimization apparatus comprising:
a database in which a constraint condition of welding by a welding robot that operates a welding torch is stored;
an interference analysis part configured to determine a welding path that does not interfere with an object to be welded based on three-dimensional CAD data of the object to be welded and the constraint condition stored in the database; and
an output part configured to output welding process information based on the welding path.

2. The welding path autonomous optimization apparatus according to claim 1, wherein
the welding process information includes at least information on a tilt angle of the welding torch and information on a welding target position.

3. The welding path autonomous optimization apparatus according to claim 1, wherein
the constraint condition includes at least a constraint condition on a tilt angle of the welding torch and a constraint condition on a welding target position.

4. The welding path autonomous optimization apparatus according to claim 1, further comprising:
a three-dimensional scanner configured to detect a shape of a workpiece; and
a pre-welding process information correction part, wherein
the pre-welding process information correction part is configured to:
obtain three-dimensional shape information of the workpiece and a groove shape prior to welding with the three-dimensional scanner;
identify a difference from the three-dimensional CAD data; and
correct the welding process information.

5. The welding path autonomous optimization apparatus according to claim 4, wherein
the pre-welding process information correction part includes:
a three-dimensional shape information obtaining part configured to obtain the three-dimensional shape information of the workpiece and the groove shape prior to welding; and
a first difference information obtaining part configured to identify a difference between: the three-dimensional shape information of the workpiece and the groove shape; and the three-dimensional CAD data.

6. The welding path autonomous optimization apparatus according to claim 1, further comprising:
a displacement gauge configured to identify a relative position between the welding robot and a groove;
a camera for observing a molten pool; and
a during-welding process information correction part, wherein
the during-welding process information correction part is configured to:
evaluate a state of the molten pool during welding from an image captured by the camera and a variation in a relative position with respect to the groove;
identify a difference from the three-dimensional CAD data; and
correct the welding process information.

7. The welding path autonomous optimization apparatus according to claim 6, wherein
the during-welding process information correction part includes:
a during-welding variation evaluation part that evaluates the state of the molten pool during welding from an image captured by the camera and the variation in a relative position with respect to the groove; and
a second difference information obtaining part configured to identify a difference between three-dimensional shape information of a workpiece obtained by the during-welding variation evaluation part and the three-dimensional CAD data.

8. A welding path autonomous optimization system comprising:
a welding robot configured to operate a welding torch;
a database in which a constraint condition of welding by a robot is stored;
an interference analysis part configured to determine a welding path that does not interfere with an object to be welded based on three-dimensional CAD data of the object to be welded and the constraint condition stored in the database; and
an output part configured to output welding process information based on the welding path.

9. A welding path autonomous optimization method comprising:
determining a welding path that does not interfere with an object to be welded based on three-dimensional CAD data of the object to be welded and a constraint condition of welding by a welding robot; and
outputting welding process information based on the welding path.

10. The welding path autonomous optimization method according to claim 9, further comprising:
obtaining three-dimensional shape information of the object to be welded, the three-dimensional shape information including at least one of three-dimensional shape information of a workpiece before welding or information of a groove shape before welding;
identifying a difference between the three-dimensional CAD data and the three-dimensional shape information of the object to be welded; and
correcting the welding process information using the difference.

11. The welding path autonomous optimization method according to claim 9, further comprising:
inputting information of a groove shape during welding;
detecting state information of a molten pool during welding;
evaluating discrepancy between positional relationships based on the information of a groove shape and the state information of a molten pool; and
correcting either a position of a welding torch or a welding condition based on the discrepancy between positional relationships.
